(19) United States
(12) Patent Application Publication
(10) Pub. No.: US 2010/0244574 A1
(43) Pub. Date: Sep. 30, 2010

(54) CHARGING DEVICE, CHARGING SYSTEM AND CHARGING METHOD

(75) Inventors: Naoyuki NISHINO, Kanagawa (JP); Yasunori OHTA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/715,412

(22) Filed: Mar. 2, 2010

(30) Foreign Application Priority Data
Mar. 31, 2009 (JP) 2009-087467

(51) Int. Cl. H02J 3/00

(52) U.S. Cl. 307/80

(57) ABSTRACT

There is provided a charging device including: a charging unit that charges plural secondary batteries that supply electric power to a portable radiation imaging device, each of plural secondary batteries being able to be installed in or removed from the portable radiation imaging device; a detecting unit that detects an extent of deterioration of each of the secondary batteries; a selecting unit that selects a secondary battery to be installed in the portable radiation imaging device such that, the smaller a planned number of images to be captured by the portable radiation imaging device, the higher the frequency of selection of a secondary battery, whose extent of deterioration is high, becomes; and an indicating unit that indicates the secondary battery selected by the selecting unit.

### CROSS-REFERENCE TO RELATED APPLICATION

This application is based on and claims priority under 35 USC 119 from Japanese Patent Application No. 2009-087467 filed on Mar. 31, 2009, which is incorporated by reference herein.

### BACKGROUND

1. Technical Field

The present invention relates to a charging device. In particular, the present invention relates to a charging device, a charging system and a charging method that charge plural secondary batteries that supply electric power to a portable radiation imaging device that can be installed in or removed from the portable radiation imaging device.

2. Related Art

Radiation detectors such as FPDs (Flat Panel Detectors), in which a radiation-sensitive layer is disposed on a TFT (Thin Film Transistor) active matrix substrate and that can convert radiation directly into digital data, and the like have been put into practice in recent years. Portable radiation imaging devices (hereinafter also called “electronic cassettes”), that capture radiation images expressed by emitted radiation by using such radiation detectors, have been put into practice. Note that there are, as methods of converting radiation in radiation detectors used in the electronic cassettes, an indirect-conversion method that converts radiation into light at a scintillator and thereafter converts the light into charges at a semiconductor layer of photodiodes or the like, and a direct-conversion method that converts radiation into charges at a semiconductor layer of amorphous silicon or the like, and the like. In these respective methods as well, there are various materials that can be used at the semiconductor layer.

Because this electronic cassette realizes a portable form, there are electronic cassettes that use, as the electric power source thereof, a secondary battery such as a nickel cadmium battery, a nickel hydrogen battery, a lithium ion battery, or the like.

There are cases in which the deterioration of a secondary battery advances due to repeated charging and discharging. Further, if the extent of the deterioration becomes great, then there are cases in which the storage capacity decreases and imaging cannot be carried out.

As a technique that can be applied to such cases, Japanese Patent Application Laid-Open (JP-A) No. 2006-43191 discloses a technique in which battery packs are structured so as to be removable, and the plural battery packs can be replaced appropriately. In this technique, by managing the plural battery packs and using the respective battery packs uniformly, it is possible to prevent an imaging device from becoming unable to be used due to insufficient charging of a specific battery pack.

Further, in a method of calculating the charge remaining in the battery starting from a fully-charged state, if plural batteries are used while being replaced plural times, the charge remaining in each battery cannot be calculated correctly. Therefore, JP-A No. 2006-174338 discloses a technique of giving an individual identification code to each battery, and storing the history of usage, the current remaining capacity, and the like per individual identification code in the memory of a camera, and, on the basis thereof, carrying out remaining charge display corresponding to the operational mode of the camera.

At an electronic cassette, the number of radiation images to be captured differs in accordance with the imaging order.

However, by applying the technique disclosed in JP-A No. 2006-43191, plural secondary batteries can be replaced appropriately, and, when the respective secondary batteries are used uniformly, the deterioration of each secondary battery proceeds uniformly, and the storage capacities of all of the secondary batteries decrease. Accordingly, there are cases in which, regardless of which of the secondary batteries is selected, the selected secondary battery is in a state in which it is not fit for usage over a long time period (the capturing of plural images).

Further, when the technique of JP-A No. 2006-174338 is applied, the capacities of plural secondary batteries can be managed individually. However, this technique does not consider how secondary batteries can be used efficiently when using plural secondary batteries.

### SUMMARY

The present invention was developed in view of the aforementioned, and provides a charging device, a charging system and a charging method that, while effectively utilizing plural secondary batteries, can suppress the occurrence of a situation in which capturing of radiation images can no longer be carried out due to deterioration of a secondary battery.

An aspect of the present invention is a charging device including: a charging unit that charges plural secondary batteries that supply electric power to a portable radiation imaging device, each of secondary batteries being able to be installed in or removed from the portable radiation imaging device; a detecting unit that detects an extent of deterioration of each of the secondary batteries; a selecting unit that selects a secondary battery to be installed in the portable radiation imaging device such that, the smaller a planned number of images to be captured by the portable radiation imaging device, the higher the frequency of selection of a secondary battery, whose extent of deterioration is high, becomes; and an indicating unit that indicates the secondary battery selected by the selecting unit.

Another aspect of the present invention is a charging system including: a charging device that charges plural secondary batteries that supply electric power to a portable radiation imaging device, each of the second batteries being able to be installed in or removed from the portable radiation imaging device; a detecting unit that detects an extent of deterioration of each of the secondary batteries; a selecting unit that selects a secondary battery to be installed in the portable radiation imaging device such that, the smaller a planned number of images to be captured by the portable radiation imaging device, the higher the frequency of selection of a secondary battery, whose extent of deterioration, becomes; and an indicating unit that indicates the secondary battery selected by the selecting unit.

Another aspect of the present invention is a method of selecting a secondary battery in a charging device that charges plural secondary batteries that supply electric power to a portable radiation imaging device, each of the second batteries being able to be installed in or removed from the portable radiation imaging device, the method including: detecting an extent of deterioration of each of the secondary batteries; selecting a secondary battery to be installed in the portable radiation imaging device such that, the smaller a planned number of images to be captured by the portable radiation imaging device, the higher the frequency of selection of a secondary battery, whose extent of deterioration is high, becomes; and indicating the secondary battery that was selected.

### BRIEF DESCRIPTION OF THE DRAWINGS

Exemplary embodiments of the present invention will be described in detail based on the following figures, wherein:

FIG. 1 is a block diagram showing the structure of a radiology information system relating to the exemplary embodiments;

FIG. 2 is a side view showing an example of a configuration of a radiation imaging system relating to the exemplary embodiments in a radiation imaging room;

FIG. 3 is a transparent perspective view showing the internal structure of an electronic cassette relating to the exemplary embodiments;

FIG. 4 is a perspective view showing the structures of a charging device and power source devices relating to the exemplary embodiments, and a state in which the power source devices are mounted on the charging device;

FIG. 5A is a perspective view showing the structure of the electronic cassette relating to the exemplary embodiments, and a state in which the power source device is installed in the electronic cassette;

FIG. 5B is a perspective view showing the structure of the electronic cassette relating to the exemplary embodiments, and a state in which the power source device is removed from the electronic cassette;

FIG. 6 is a block diagram showing the structure of main portions of an electrical system of the radiation imaging system relating to the exemplary embodiments;

FIG. 7 is a flowchart showing the flow of processing of a charging control processing program relating to the exemplary embodiments;

FIG. 8 is a schematic drawing showing the structure of imaging order data relating to the exemplary embodiments;

FIG. 9 is a flowchart showing the flow of processing of a program for indicating the power source device to be installed relating to a first exemplary embodiment;

FIG. 10 is a drawing showing changes in extents of deterioration (low, medium, high) of seven power source devices (#001 through #007);

FIG. 11 is a flowchart showing the flow of processing of a program for indicating the power source device to be installed relating to a second exemplary embodiment; and

FIG. 12 is a perspective view showing the structure of power source devices relating to another exemplary embodiment.

### DETAILED DESCRIPTION

Here, description will be given of examples in which aspects of the present invention are applied to a radiology information system that is a system that collectively manages data that is handled in the radiology department of a hospital.

### First Exemplary Embodiment

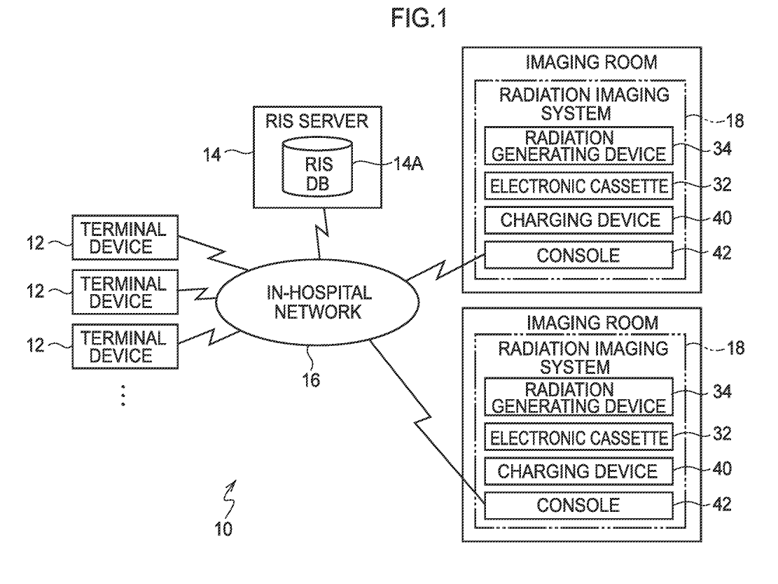

First, the structure of a radiology information system 10 (hereinafter called “RIS”) relating to the present exemplary embodiment will be described with reference to FIG. 1.

The RIS 10 is a system for carrying out data management such as scheduling of examinations/treatments, recording of diagnoses, and the like in a radiology department. The RIS 10 structures a part of a hospital information system (hereinafter called “HIS”).

The RIS 10 has plural imaging request terminal devices (hereinafter called “terminal devices”) 12, an RIS server 14, and radiation imaging systems (hereinafter called “imaging systems”) 18 that are individually set in radiation imaging rooms (or operating rooms) within the hospital. These are respectively connected to an in-hospital network 16 that is formed from a wired or wireless LAN (Local Area Network) or the like. Note that the RIS 10 structures a part of the HIS that is provided within the same hospital. An HIS server (not illustrated) that manages the entire HIS also is connected to the in-hospital network 16.

The terminal device 12 is for a doctor or a radiology technician to carrying out inputting, browsing, and the like of diagnostic information and reservations of facilities. Requests for imaging of radiation images and reservations for imaging are also made via the terminal device 12. Each of the terminal devices 12 is structured from a personal computer having a display device, and can communicate back and forth with the RIS 14 via the in-hospital network 16.

On the other hand, the RIS server 14 accepts imaging requests from the respective terminal devices 12, and manages the imaging schedule of radiation images at the imaging systems 18. The RIS server 14 includes a database 14A.

The database 14A includes data relating to a patient (hereinafter called “patient data”) such as attribute data of the patient (name, ID, sex, birthdate, age, blood type, weight, and the like), the patient's history of past illness, history of past examinations/treatments, radiation images that were captured in the past, and the like. The database 14A further includes data relating to electronic cassettes 32 (hereinafter called “electronic cassette data”), that will be described later and that are used in the imaging systems 18, such as the ID number, type, size, sensitivity, regions to be imaged at which the electronic cassette 32 can be used, the usage start date, number of times of usage, and the like. The database 14A also includes environment data expressing the environments in which radiation images were captured by using the electronic cassettes 32, i.e., environments in which the electronic cassettes 32 were used (as examples, a radiation imaging room, an operating room, or the like).

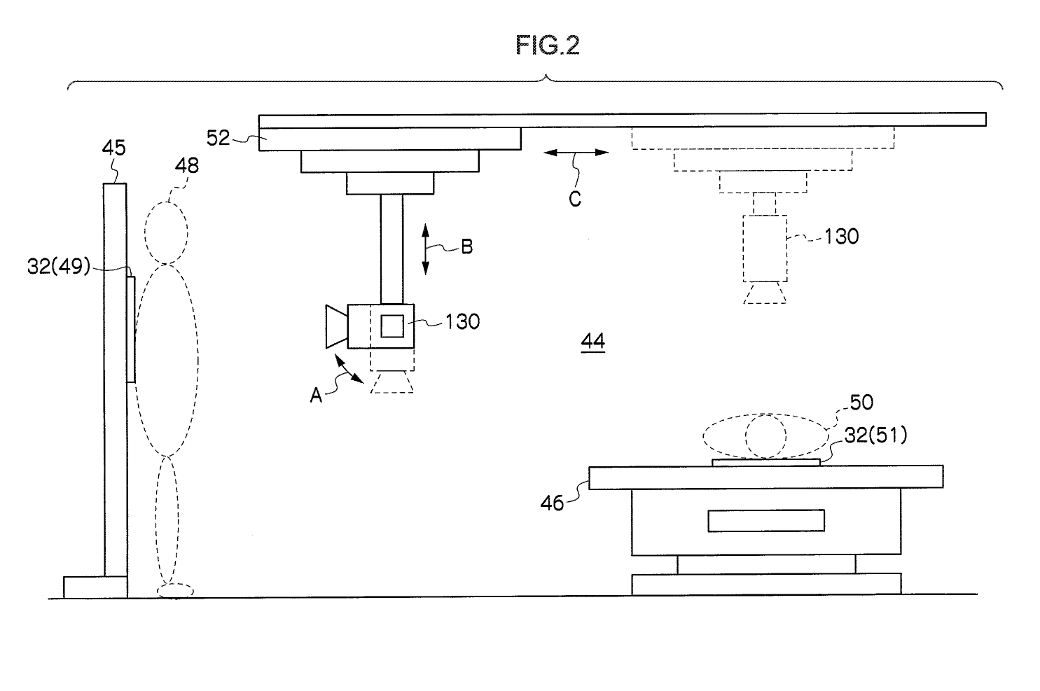

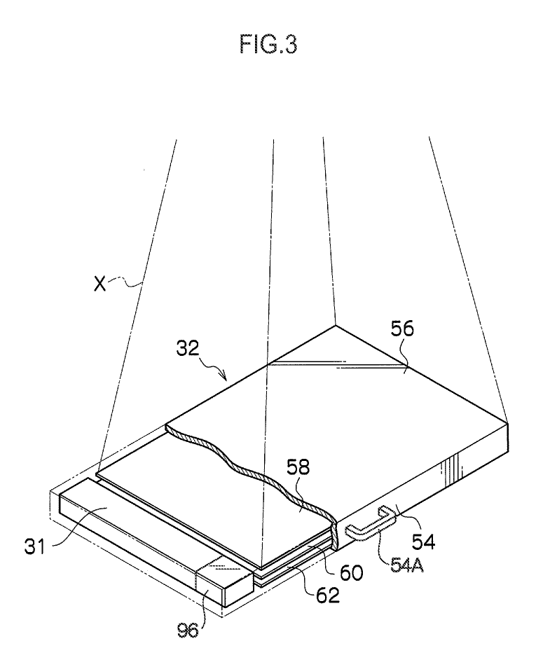

The imaging system 18 carries out capturing of radiation images by operation of a doctor or a radiology technician in accordance with instructions from the RIS server 14. The imaging system 18 has a radiation generating device 34, the electronic cassette 32, a charging device 40, and a console 42. The radiation generating device 34 irradiates, from a radiation source 130 (see FIG. 2 as well) and onto a patient, radiation X (see FIG. 3 as well) of a radiation amount conforming to exposure conditions. The electronic cassette 32 incorporates therein a radiation detector 60 (see FIG. 3 as well) that absorbs the radiation X that has been transmitted through the imaged region of the patient, and generates charges, and, on the basis of the generated charge amount, generates image data expressing a radiation image. The charging device 40 charges power source devices 96 (see FIG. 3 as well) that are structured so as to be able to be installed in and removed from the electronic cassette 32. The console 42 controls the electronic cassette 32, the radiation generating device 34, and the charging device 40.

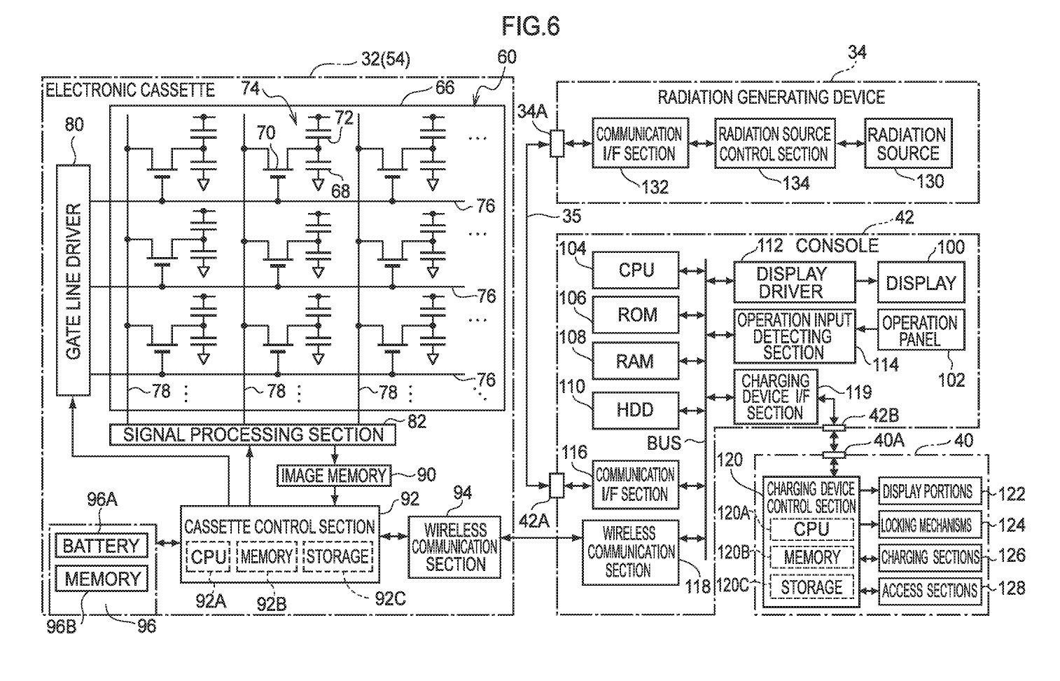

The console 42 acquires, from the RIS server 14, various types of data that are included in the database 14A, and stores the data in an HDD (hard disk drive) 110 (see FIG. 6 as well) that will be described later. Further, on the basis of this data, the console 42 controls the electronic cassette 32, the radiation generating device 34, and the charging device 40. An example of the configuration, in a radiation imaging room 44, of the imaging system 18 relating to the present exemplary embodiment is shown in FIG. 2.

As shown in FIG. 2, a rack 45 and a bed 46 are set in the radiation imaging room 44. The rack 45 holds the electronic cassette 32 when radiation imaging is carried out with a patient in a standing state. The bed is for a patient to lay upon when radiation imaging is carried out with a patient in a lying-down state. The space in front of the rack 45 is an imaging position 48 for the patient when radiation imaging is carried out with a patient in a standing state. The space above the bed 46 is an imaging position 50 for the patient when radiation imaging is carried out with a patient in a lying-down state.

Further, a supporting/moving mechanism 52, that supports the radiation source 130 such that the radiation source 130 is rotatable around a horizontal axis (i.e., in the direction of arrow A in FIG. 2), is movable in the vertical direction (the direction of arrow B in FIG. 2), and is movable in the horizontal direction (the direction of arrow C in FIG. 2) is provided in the radiation imaging room 44. Owing to the supporting/moving mechanism 52, both radiation imaging with a patient in the standing state and radiation imaging with a patient in the lying-down state are possible by radiation from the single radiation source 130. Here, the supporting/moving mechanism 52 has a driving source that rotates the radiation source 130 around the horizontal axis, a driving source that moves the radiation source 130 in the vertical direction, and a driving source that moves the radiation source 130 in the horizontal direction (none of these driving sources is illustrated).

If the imaging posture is the standing posture, the electronic cassette 32 is positioned at a position 49, or the like, that is determined in advance and is held at the rack 45. Further, if the imaging posture is the lying-down posture, the electronic cassette 32 is positioned at a position 51, or the like, that is determined in advance and is located beneath the region of imaging and on the bed 46.

In the imaging system 18 relating to the present exemplary embodiment, the radiation generating device 34 and the console 42 are connected by a cable such that transmission and reception of various types of data therebetween are carried out by wired communication. However, this cable is not illustrated in FIG. 2. Further, in the imaging system 18 relating to the present exemplary embodiment, transmission and reception of various types of data between the electronic cassette 32 and the console 42 are carried out by wireless communication.

Note that the electronic cassette 32 is not used only in a radiation imaging room or an operating room, and, due to the portability thereof can, for example, be used in medical examinations or in doctors' rounds within a hospital or the like as well.

The internal structure of the electronic cassette 32 relating to the present exemplary embodiment is shown in FIG. 3.

As shown in FIG. 3, the electronic cassette 32 has a housing 54 formed from a material through which the radiation X is transmitted. The electronic cassette 32 is a structure that is waterproof and airtight. When the electronic cassette 32 is being used in an operating room or the like, there is the concern that blood or other various germs will adhere thereto. Thus, by making the electronic cassette 32 be a waterproof and airtight structure and disinfected or cleaned as needed, the one electronic cassette 32 can be used repeatedly.

A grid 58, the radiation detector 60, and a lead plate 62 are disposed in that order within the housing 54. The grid 58 removes the scattered radiation of the radiation X due to the patient, from an irradiated surface 56 side of the housing 54 onto which the radiation X is irradiated. The radiation detector 60 detects the radiation X that has been transmitted through the patient. The lead plate 62 absorbs the back-scattered radiation of the radiation X. Note that the irradiated surface 56 of the housing 54 may be structured as the grid 58.

A case 31, that accommodates electronic circuits including a microcomputer and accommodates the power source device 96 that is chargeable and removable, is disposed at one end of the interior of the housing 54. The radiation detector 60 and the aforementioned electronic circuits are operated by electric power that is supplied from the power source device 96 disposed in the case 31. In order to avoid damage, that accompanies the irradiation of the radiation X, to the various types of circuits that are accommodated within the case 31, a lead plate or the like may be disposed at the irradiated surface 56 side of the case 31. Note that the electronic cassette 32 relating to the present exemplary embodiment is a parallelepiped at which the shape of the irradiated surface 56 is rectangular, and the case 31 is disposed at one end portion in the longitudinal direction thereof.

A handle 54A, that is grasped when the electronic cassette 32 is moved, is provided at a predetermined position of the outer wall of the housing 54. Note that, at the electronic cassette 32 relating to the present exemplary embodiment, the handle 54A is provided at the central portion of a side wall of the case 54, which side wall extends in the longitudinal direction of the irradiated surface 56. However, the present invention is not limited to the same. For example, the handle 54A may be disposed at the central portion of a side wall that extends in the direction of the short side of the irradiated surface 56, or at a position that is offset by a distance that considers the offset of the center of gravity position of the electronic cassette 32 from the central portion of either of these side walls, or at another position.

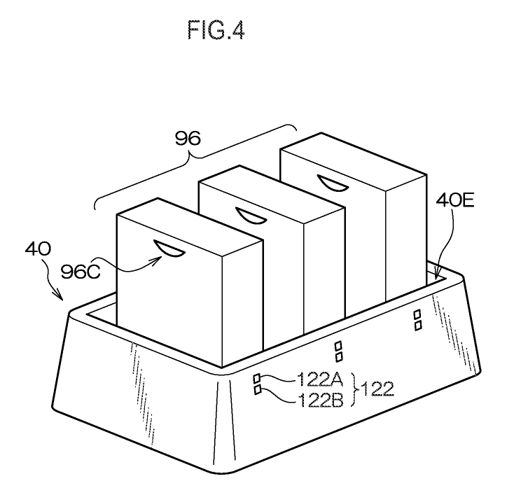

On the other hand, the structure of the charging device 40 relating to the present exemplary embodiment is shown in FIG. 4.

The charging device 40 can charge the plural power source devices 96. An opening 40E, for installation and removal of the power source devices 96, is provided in the upper portion of the charging device 40.

Connectors (not illustrated) that electrically connect to the power source devices 96 that are inserted from the opening 40E, are provided at the floor surface of the interior of the charging device 40 relating to the present exemplary embodiment. The inserted power source devices 96 are charged in the state of being electrically connected to these connectors.

Locking mechanisms 124 (not shown in FIG. 4, refer to FIG. 6) are provided at a side wall of the interior of the charging device 40. The locking mechanisms 124 position and fix (lock) the inserted power source devices 96 individually at predetermined charging positions (the positions shown in FIG. 4).

Moreover, display portions 122, that each are for displaying whether or not the corresponding power source device 96 can be used, whether or not the corresponding power source device 96 needs to be replaced, and the like, are respectively provided at positions corresponding to the installed positions of the respective power source devices 96, at an exterior side wall (housing surface) of the charging device 40. Note that, in the charging device 40 relating to the present exemplary embodiment, two display portions that are a display portion 122A, that is for indicating whether or not the power source device 96 can be used, and a display portion 122B, that is for indicating whether or not the power source device 96 needs to be replaced, are respectively provided as the display portion 122. In the charging device 40 relating to the present exemplary embodiment, light-emitting diodes are used as the display portions 122. However, the present invention is not limited to the same, and the display portions may be light-emitting elements other than light-emitting diodes, or other display means such as liquid crystal displays, organic EL displays, or the like.

Note that, as shown in FIG. 4, a recess 96C that the fingernail of a user catches on when the user removes the power source device 96 from the charging device 40, is provided at each of the power source devices 96. Facilitation of the removal operation of the respective power source devices 96 is thereby aimed for.

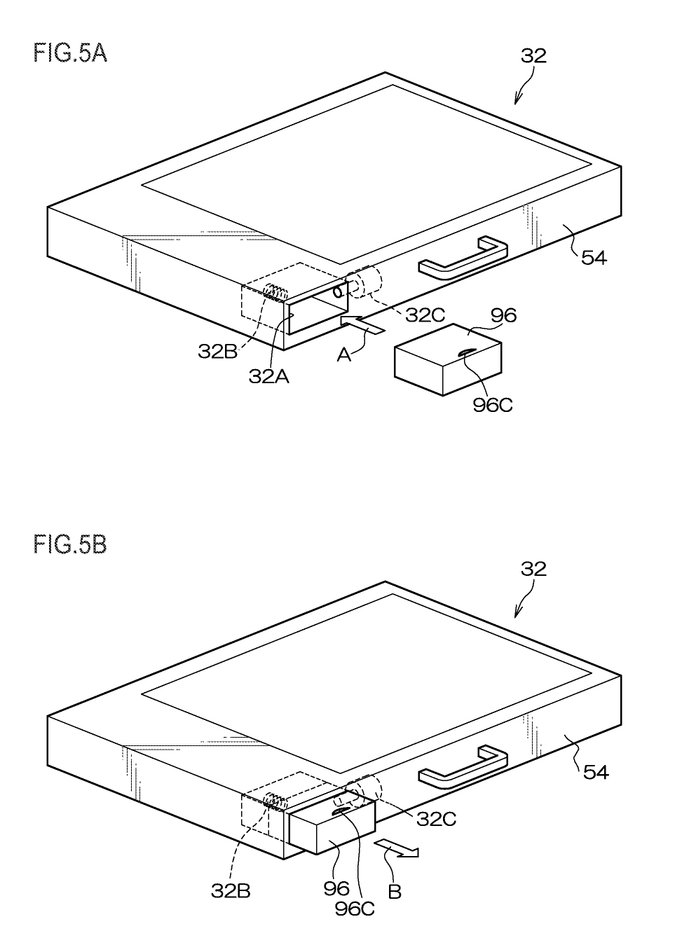

As shown in FIG. 5A, an opening 32A for the installing of the power source device 96 is provided in a vicinity of an end portion of an outer wall of the housing 54 at the electronic cassette 32 relating to the present exemplary embodiment. Further, an urging member 32B, that urges the power source device 96 in the direction opposite the direction of insertion (the direction of arrow A in FIG. 5A) of the power source device 96, is provided at the deepest portion of the interior of the opening 32A. Note that, in the electronic cassette 32 relating to the present exemplary embodiment, a spring is used as the urging member 32B. However, the present invention is not limited to the same, and another urging member such as a plate spring, a solenoid or the like may be used.

A connector (not shown) for electrically connecting with the power source device 96 that is inserted in from the opening 32A, is provided at the aforementioned deepest portion of the electronic cassette 32 relating to the present exemplary embodiment. The inserted power source device 96 supplies electric power to the respective electric power driving sections of the electronic cassette 32, in a state in which the power source device 96 is electrically connected to this connector.

A fixing member 32C, that fixes the inserted power source device 96 at the position at which the power source device 96 is electrically connected to the connector, is provided at an inner side wall side of the opening 32A of the electronic cassette 32 relating to the present exemplary embodiment. Note that a solenoid is used as the fixing member 32C in the electronic cassette 32 relating to the present exemplary embodiment. However, the present invention is not limited to the same, and another fixing member that can fix the power source device 96 may be used.

In the electronic cassette 32 relating to the present exemplary embodiment, as shown in FIG. 5A, when the power source device 96 is inserted in the direction of arrow A in FIG. 5A with respect to the opening 32A, at the point in time when the power source device 96 is positioned at the position of being electrically connected to the connector, a plunger of the fixing member 32C that is structured by a solenoid projects-out and pushes the side surface of the power source device 96. The power source device 96 is thereby fixed. Then, when imaging is finished, as shown in FIG. 5B, due to the plunger of the fixing member 32C being pulled-in, the power source device 96 is pushed in the direction of arrow B in FIG. 5B by the urging force of the urging member 32B, and a portion of the power source device 96 projects-out from the electronic cassette 32. Accordingly, the user can easily remove the power source device 96 from the electronic cassette 32 by catching his/her fingernail on the recess 96C and pulling the power source device 96 out.

Next, the main structures of the electrical system of the imaging system 18 relating to the present exemplary embodiment will be described with reference to FIG. 6.

As shown in FIG. 6, a connection terminal 34A for carrying out communication with the console 42 is provided at the radiation generating device 34. A connection terminal 42A for carrying out communication with the radiation generating device 34 is provided at the console 42. The connection terminal 34A of the radiation generating device 34 and the connection terminal 42A of the console 42 are connected by a communication cable 35.

A photoelectric converting layer, that absorbs the radiation X and converts it into charges, is layered on a TFT active matrix substrate 66 at the radiation detector 60 that is incorporated in the electronic cassette 32. The photoelectric converting layer is formed from, for example, amorphous a-Se (amorphous selenium) whose main component is selenium (e.g., a content of greater than or equal to 50%). When the radiation X is irradiated, the photoelectric converting layer generates, at the interior thereof, charges (electron-hole pairs) of a charge amount corresponding to the irradiated radiation amount, and thereby converts the irradiated radiation X into charges. Note that, instead of a radiation-charge converting material that directly converts the radiation X into charges such as amorphous selenium, the radiation detector 60 may convert the radiation X into charges indirectly by using a fluorescent material and photoelectric converting elements (photodiodes). Gadolinium oxysulfide (GOS) and cesium iodide (CsI) are well known as fluorescent materials. In this case, conversion from the radiation X into light is carried out by the fluorescent material, and the conversion from light into charges is carried out by the photodiodes that are the photoelectric converting elements.

Numerous storage capacitors 68 and pixel portions 74 are arranged in the form of a matrix on the TFT active matrix substrate 66. (In FIG. 6, the photoelectric converting layer corresponding to the individual pixel portions 74 is shown schematically as photoelectric converting portions 72.) The storage capacitors 68 accumulate the charges generated at the photoelectric converting layer. TFTs 70 for reading-out the charges accumulated in the storage capacitors 68 are provided at the pixel portions 74. The charges, that are generated at the photoelectric converting layer accompanying the irradiation of the radiation X onto the electronic cassette 32, are accumulated in the storage capacitors 68 of the individual pixel portions 74. Due thereto, the image, that is carried by the radiation X irradiated on the electronic cassette 32, is converted into charge data and is held at the radiation detector 60.

Plural gate lines 76 and plural data lines 78 are provided at the TFT active matrix substrate 66. The gate lines 76 extend in a given direction (the row direction) and turn the TFTs 70 of the individual pixel portions 74 on and off. The data lines 78 extend in a direction (the column direction) orthogonal to the gate lines 76 and read-out the accumulated charges from the storage capacitors 68 via the TFTs 70 that have been turned on. The individual gate lines 76 are connected to a gate line driver 80, and the individual data lines 78 are connected to a signal processing section 82. When charges are accumulated in the storage capacitors 68 of the individual pixel portions 74, the TFTs 70 of the individual pixel portions 74 are turned on in order in units of rows by signals supplied from the gate line driver 80 via the gate lines 76. The charges, that are accumulated in the storage capacitors 68 of the pixel portions 74 whose TFTs 70 have been turned on, are transferred through the data lines 78 as analog electrical signals and are inputted to the signal processing section 82. Accordingly, the charges, that are accumulated in the storage capacitors 68 of the individual pixel portions 74, are read-out in order in units of rows.

Although not illustrated, the signal processing section 82 is equipped with an amplifier and a sample hold circuit that are provided for each of the individual data lines 78. The charge signals that are transferred through the individual data lines 78 are amplified at the amplifiers, and thereafter, are held in the sample hold circuits. Further, a multiplexer and an A/D (analog/digital) converter are connected in that order to the output sides of the sample hold circuits. The charge signals, that are held in the individual sample hold circuits, are inputted in order (serially) to the multiplexer, and are converted into digital image data by the A/D converter.

An image memory 90 is connected to the signal processing section 82. The image data, that are outputted from the A/D converter of the signal processing section 82, are stored in order in the image memory 90. The image memory 90 has a storage capacity that can store image data of a predetermined number of images. Each time capturing of a radiation image is carried out, the image data obtained by the capturing is successively stored in the image memory 90.

The image memory 90 is connected to a cassette control section 92 that controls the operations of the entire electronic cassette 32. The cassette control section 92 is structured by a microcomputer, and has a CPU (central processing unit) 92A, a memory 92B that includes a ROM and a RAM, and a non-volatile storage 92C formed from an HDD or a flash memory or the like.

A wireless communication section 94 is connected to the cassette control section 92. The wireless communication section 94 corresponds to wireless LAN (Local Area Network) standards exemplified by IEEE (Institute of Electrical and Electronics Engineers) 802.11a/b/g or the like. The wireless communication section 94 controls the transfer of various types of data to and from external devices by wireless communication. The cassette control section 92 can communicate wirelessly with the console 42 via the wireless communication section 94, such that the transmission and reception of various types of data to and from the console 42 are possible. The cassette control section 92 stores exposure conditions, that will be described later and that are received from the console 42 via the wireless communication section 94, and starts reading-out of charges on the basis of these exposure conditions.

Further, the power source device 96 is connected to the cassette control section 92 in a state of being fixed by the fixing member 32C (see FIG. 5 as well).

The power source device 96 relating to the present exemplary embodiment has a secondary battery (hereinafter called “battery”) that is structured so as to be chargeable, and a memory 96B. The secondary battery 96A supplies electric power to the respective electric power driving sections of the electronic cassette 32. The memory 96B stores respective types of data such as usage situation data that expresses the usage situation of the power source device 96 that is correlated with the extent of deterioration of the battery 96A, and the like. Note that, in the power source device 96 relating to the present exemplary embodiment, a non-volatile, rewritable memory (a flash memory in the present exemplary embodiment) is used as the memory 96B. However, the present invention is not limited to the same and may be a form in which a volatile memory such as a RAM or the like is used, and the battery 96A is used as a back-up power source of the memory 96B. Further, a nickel cadmium battery is used as the battery 96A in the power source device 96 relating to the present exemplary embodiment. However, the present invention is not limited to the same, and may be a form in which another secondary battery such as a nickel hydrogen battery, a lithium ion battery, or the like is used.

In the state in which the power source device 96 is installed, the above-described various circuits and respective elements of the electronic cassette 32 relating to the present exemplary embodiment (the gate line driver 80, the signal processing section 82, the image memory 90, the wireless communication section 94, the microcomputer that functions as the cassette control section 92, and the like) are operated by electric power that is supplied from the battery 96A of that power source device 96. Further, in the state in which the power source device 96 is installed, the cassette control section 92 can access the memory 96B of that power source device 96. Note that, in FIG. 6, illustration of the wires that connect the power source device 96 and the various circuits and respective elements is omitted.

On the other hand, the console 42 is structured as a server computer. The console 42 has a display 100, that displays operation menus, captured radiation images and the like, and an operation panel 102 that includes plural keys and at which various types of data and operating instructions are inputted.

Further, the console 42 relating to the present exemplary embodiment includes a CPU 104, a ROM 106, a RAM 108, the HDD 110, a display driver 112, and an operation input detecting section 114. The CPU 104 governs the operations of the overall device. Various types of programs, including control programs, and the like are stored in advance in the ROM 106. The RAM 108 temporarily stores various types of data. The HDD 110 stores and holds various types of data. The display driver 112 controls the display of various types of data on the display 100. The operation input detecting section 114 detects the operated state of the operation panel 102. Further, the console 42 has a communication interface (I/F) section 116, a wireless communication section 118, and a charging device I/F section 119. The communication interface (I/F) section 116 is connected to the connection terminal 42A and carries out transmission and reception of various types of data, such as exposure conditions that will be described later and the like, with the radiation generating device 34 via the connection terminal 42A and the communication cable 35. The wireless communication section 118 carries out transmission and reception of various types of data, such as exposure conditions and image data and the like, with the electronic cassette 32 by wireless communication. The charging device 40 is connected to the charging device I/F section 119, and the charging device I/F section 119 carries out communication with the charging device 40.

The CPU 104, the ROM 106, the RAM 108, the HDD 110, the display driver 112, the operation input detecting section 114, the communication I/F section 116, the wireless communication section 118 and the charging device I/F section 119 are connected to one another via a system bus BUS. Accordingly, the CPU 104 can access the ROM 106, the RAM 108 and the HDD 110, and can respectively carry out control of display of various types of data on the display 100 via the display driver 112, control of transmission and reception of various types of data with the radiation generating device 34 via the communication I/F section 116, control of transmission and reception of various types of data with the electronic cassette 32 via the wireless communication section 118, and control of transmission and reception of various types of data with the charging device 40 via the charging device I/F section 119. Further, the CPU 104 can grasp the operated state of the operation panel 102 by a user via the operation input detecting section 114.

On the other hand, the charging device 40 further has a charging device control section 120, charging sections 126, and memory access sections 128 (hereinafter called “access sections”). The charging device control section 120 controls the overall operation of the charging device 40. The charging sections 126 carry out charging of the batteries 96A, that are provided at the power source devices 96 that are installed in the opening 40E, by using electric power supplied from a commercial power source. The access sections 128 carry out access to the memories 96B that are provided in the installed power source devices 96. The access section 128 may access the memory 96B provided in the power source device 96 by a wireless technique such as RFID, or may access the memory 96B by using an SM Bus such as a smart battery.

The charging device control section 120 as well is structured by a microcomputer, and has a CPU 120A, a memory 120B including a ROM and a RAM, and a non-volatile storage 120C formed from an HDD or a flash memory or the like.

The charging device control section 120 is connected to the display sections 122, the locking mechanisms 124, the charging sections 126, and the access sections 128. The charging device control section 120 can carry out communication with the charging device I/F section 119, and, via the access sections 128, access to the memories 96B of the power source devices 96 installed in the opening 40E. Further, the charging device control section 120 can respectively carry out control of the operations of the respective sections such as the display sections 122, the locking mechanisms 124 and the like, and control of the charging of the batteries 96A via the charging sections 126.

Further, the charging device control section 120 is connected to the charging device I/F section 119, and can carry out transfer of various types of data with the console 42 via the charging device I/F section 119.

A connection terminal 40A and a connection terminal 42B for wires, that connect the charging device control section 120 and the charging device I/F section 119, are provided at the charging device 40 and the console 42.

On the other hand, the radiation generating device 34 has a radiation source 130, a communication I/F section 132, and a radiation source control section 134. The radiation source 130 emits the radiation X. The communication I/F section 32 transmits and receives various types of data, such as exposure conditions and the like, to and from the console 42. The radiation source control section 134 controls the radiation source 130 on the basis of received exposure conditions.

The radiation source control section 134 also is structured by a microcomputer, and stores the received exposure conditions and posture data. The exposure conditions received from the console 42 include data such as the tube voltage, the tube current, the irradiation time period, and the like. The radiation source control section 134 causes the radiation X to be irradiated from the radiation source 130 on the basis of the received exposure conditions.

Operation of the imaging system 18 relating to the present exemplary embodiment will be described next.

In the imaging system 18 relating to the present exemplary embodiment, the plural power source devices 96 are readied, and, at the time of imaging, any of the power source devices 96 is installed in the opening 32A of the electronic cassette 32 and imaging is carried out.

The plural power source devices 96 are respectively installed in the opening 40E of the charging device 40, and charging of the batteries 96A is carried out.

The charging device 40 relating to the present exemplary embodiment can carry out usual charging with the electric power that is supplied in the charging of the battery 96A being within a predetermined appropriate range, and low-speed charging with the electric power that is supplied to the battery 96A being lower than the appropriate range, and high-speed charging with the electric power that is supplied in the charging of the battery 96A being higher than the appropriate range.

There are cases in which, due to repeated charging and discharging, the deterioration of the battery 96A provided in the power source device 96 advances, and, when the extent of deterioration becomes great, the storage capacity decreases and imaging can no longer be carried out. Further, the greater the charge voltage and discharge voltage of the battery 96A, the faster the progression of the deterioration.

In order to distinguish the extent of deterioration at the battery 96A provided at the power source device 96, in the present exemplary embodiment, a storage area, that stores the number of times of low-speed charging, the number of times of usual charging, and the number of times of rapid charging, is provided in the memory 96B of the power source device 96.

When the power source device 96 is installed in the opening 40E, charging control processing that will be described later is carried out, and the power source device 96 accesses, via the access section 128, the memory 96B that is provided in that power source device 96. Then, the power source device 96, via charging control processing, reads-out the number of times of low-speed charging, the number of times of usual charging, and the number of times of rapid charging that are stored in that memory 96B, and, on the basis of the respective numbers of times of charging, detects the extent of deterioration, and carries out one of low-speed charging, usual charging and rapid charging in accordance with the extent of deterioration.

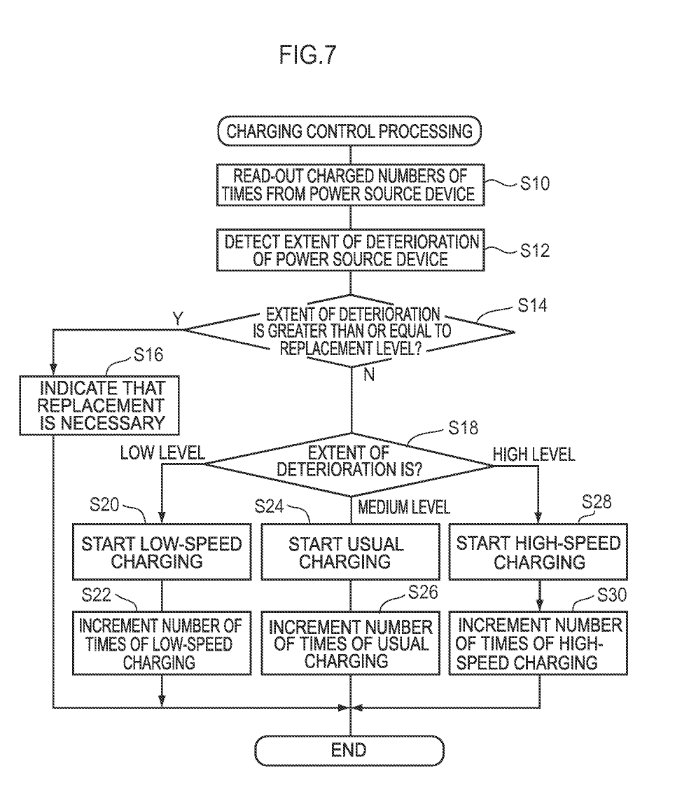

A flowchart showing the flow of processing of the charging control processing program that is executed by the CPU 120A relating to the present exemplary embodiment is shown in FIG. 7. Note that this program is stored in advance in a predetermined area of the ROM included in the memory 120B, and is executed by the CPU 120A when the power source device 96 is installed in the opening 40E.

In step S10 of FIG. 7, the CPU 120A accesses, via the access section 128, the memory 96B that is provided in the power source device 96 installed in the opening 40E this time, and reads-out the number of times of low-speed charging, the number of times of usual charging, and the number of times of rapid charging that are stored in that memory 96B.

In next step S12, the CPU 120 carries out, on the number of times of low-speed charging, the number of times of usual charging and the number of times of rapid charging that were read-out in the processing of above step S10, predetermined weighted addition by using weighting coefficients that are set such that, the greater the charge voltage of the charging, the greater the weighting coefficient.

For example, weighted addition is carried out by making the weighting coefficient for the number of times of low-speed charging be “0.8”, the weighting coefficient for the number of times of usual charging be “1.0”, and the weighting coefficient for the number of times of high-speed charging be “2.0”.

Then, in present step S12, the CPU 120A detects the extent of deterioration of the power source device 96 by considering that, the greater the value obtained as the result of the addition, the more the power source device 96 has deteriorated.

Due thereto, the greater the number of times of charging of the power source device 96, the greater the extent of deterioration is detected to be. Further, even with the same number of times of charging, the higher the proportion of the number of times of usual charging or rapid charging, the greater the extent of deterioration is detected to be.

In next step S14, the CPU 120A judges whether or not the extent of deterioration detected in the processing of above step S12 is greater than or equal to a predetermined replacement level that is not even suited to the capturing of one radiation image. If the judgment is affirmative, the routine moves on to step S16, whereas if the judgment is negative, the routine proceeds to step S18.

In step S16, the CPU 120 effects control such that only the display portion 122B, that corresponds to the power source device 96 whose extent of deterioration is judged to be greater than or equal to the replacement level, is set in a predetermined light-emitting state (a flashing state in the present exemplary embodiment) that indicates that replacement is necessary. Thereafter, the present charging control processing program ends.

The person carrying out the imaging operation removes the power source device 96, at which the light-emitting state of the display portion 122B is a flashing state, from the charging device 40, and replaces it with a new power source device 96. Due thereto, the power source device 96, that has deteriorated to the extent that it is not even suitable for capturing of a radiation image, is not used as is.

On the other hand, in step S18, when the extent of deterioration detected by the processing of above step S12 is shown by deterioration levels of plural stages (in the present exemplary embodiment, three stages that are high level, medium level, and low level), the CPU 120A judges which of the levels the extent of deterioration is. If the extent of deterioration is low level, the routine moves on to step S20. If the extent of deterioration is medium level, the routine proceeds to step S24. If the extent of deterioration is high level, the routine moves on to step S28.

In step S20, the CPU 120A starts low-speed charging of the power source device 96 that is installed in the opening 40E this time.

In next step S22, the CPU 120A accesses, via the access section 128, the memory 96B that is provided in the power source device 96 installed in the opening 40E this time, and increments the number of times of low-speed charging that is stored in that memory 96B. Thereafter, the present charging control processing program ends.

On the other hand, in step S24, the CPU 120A starts usual charging of the power source device 96 that is installed in the opening 40E this time.

In next step S26, the CPU 120A accesses, via the access section 128, the memory 96B that is provided in the power source device 96 installed in the opening 40E this time, and increments the number of times of usual charging that is stored in that memory 96B. Thereafter, the present charging control processing program ends.

On the other hand, in step S28, the CPU 120A starts high-speed charging of the power source device 96 that is installed in the opening 40E this time.

In next step S30, the CPU 120A accesses, via the access section 128, the memory 96B that is provided in the power source device 96 installed in the opening 40E this time, and increments the number of times of high-speed charging that is stored in that memory 96B. Thereafter, the present charging control processing program ends.

In this way, because the power source device 96 whose extent of deterioration is low is charged at low-speed, the advance of the deterioration is slow and the charging time is long. On the other hand, because the power source device 96 whose extent of deterioration is high is charged at high-speed, the advance of the deterioration is fast but the charging time is short.

Note that the charging device 40 may detect the extents of deterioration of the respective power source devices 96 that are installed in the opening 40E, and, if there does not exist the power source device 96 having an extent of deterioration of a low level, the charging device 40 may indicate that replacement of the power source device 96 having the highest extent of deterioration is needed. In this way, there exists at least one power source device 96 whose extent of deterioration is low level.

On the other hand, when a radiation image is to be captured, the terminal device 12 (see FIG. 1) accepts an imaging request from the doctor or radiology technician. This imaging request specifies the environment in which the electronic cassette 32 is to be used, the time/date of the imaging, the region that is the object of imaging, the number of images to be captured, the imaging posture, and exposure conditions such as the tube voltage, the amount of radiation to be irradiated, and the like.

The terminal device 12 notifies the RIS server 14 of the contents of the accepted imaging request. The RIS server 14 stores the contents of the imaging request, that were notified from the terminal device 12, as imaging order data in the database 14A.

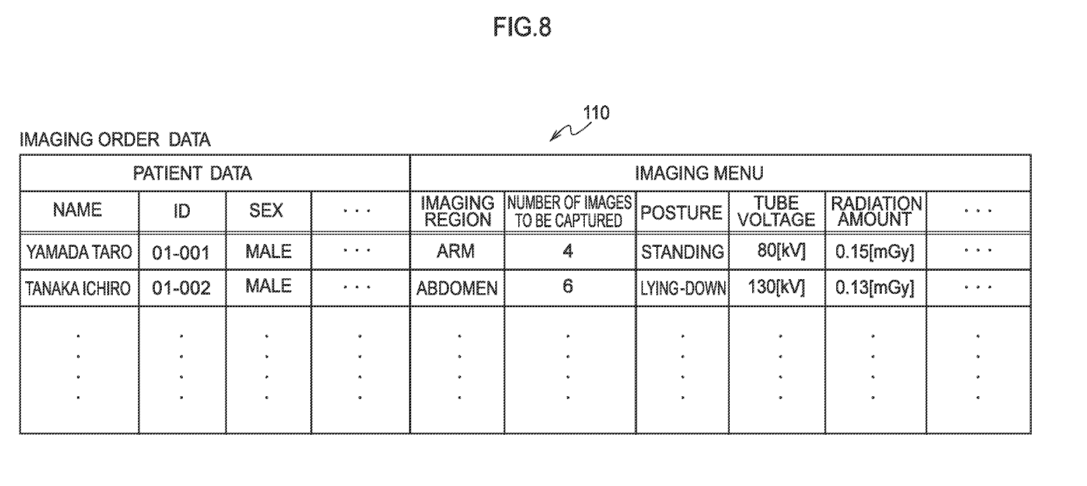

Imaging order data relating to the present exemplary embodiment is shown schematically in FIG. 8.

As shown in FIG. 8, the imaging order data relating to the present exemplary embodiment is structured in a state in which patient data relating to the patient for whom imaging is planned such as the name, ID, sex, and the like, and imaging menus relating to the radiation imaging of the corresponding patient, such as the aforementioned imaging region, number of images to be captured, posture, tube voltage, radiation amount and the like, are combined.

The imaging order data shown in FIG. 8 stores data expressing, for example, that the ID of patient “Yamada Taro” is “01-001”, his sex is “male”, the region to be imaged is the “arm”, the number of images to be captured is four, and the posture of the patient during imaging is “standing”.

By accessing the RIS server 14, the console 42 acquires the imaging order data from the RIS server 14, displays the contents of the imaging order data on the display 100, and transmits, to the charging device 40, number of images data that expresses the number of images to be captured, that is included in that imaging order data, as the planned number of images to be captured.

Note that, in the present exemplary embodiment, each time imaging order data is acquired, the number of images data, that expresses the number of images to be captured that is included in the imaging order data as the planned number of images to be captured, is transmitted to the charging device 40. However, for example, when the electronic cassette 32 is used in doctors' rounds or the like, the numbers of images to be captured that are included in plural imaging order data of patients on which imaging is to be carried out during rounds may be totaled, and number of images data, that expresses the number of images to be captured, that is obtained as a result of the totaling, as the planned number of images to be captured, may be transmitted to the charging device 40.

When the charging device 40 receives the number of images data, the charging device 40 carries out indication of the power source device to be installed that will be described hereinafter, and selects the power source device 96 that is to be installed in the electronic cassette 32 such that, the smaller the planned number of images to be captured, the higher the frequency of selection of the power source device 96 having a high extent of deterioration will become, and indicates the power source device 96 that has been selected.

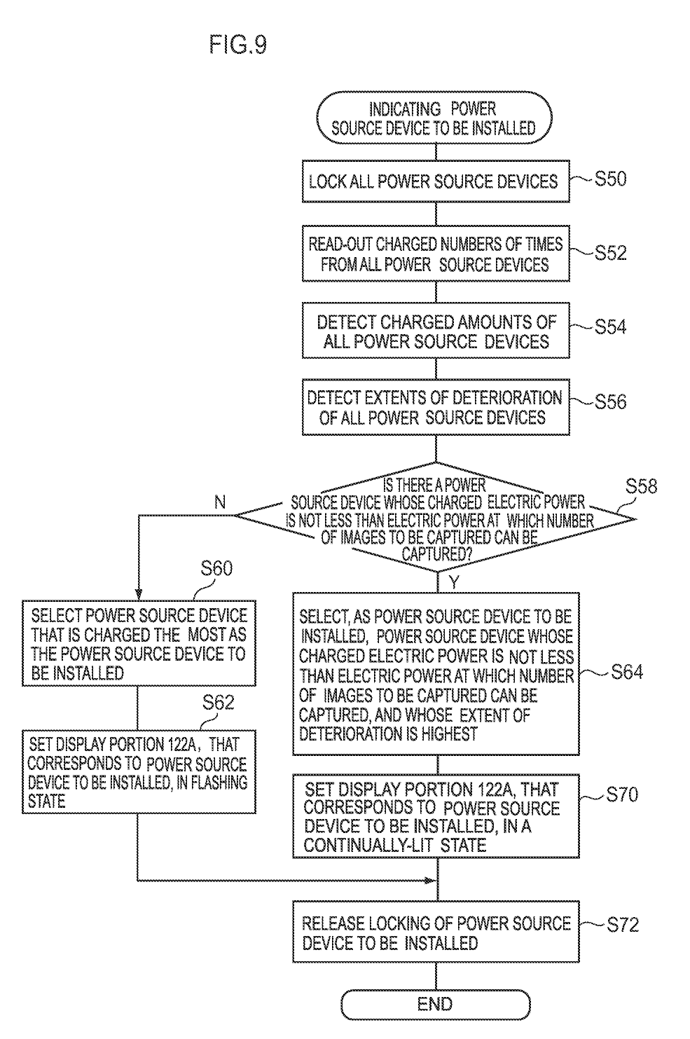

A flowchart showing the flow of the program for indication of the power source device to be installed that is executed by the CPU 120A relating to the present exemplary embodiment is shown in FIG. 9. Note that this program is stored in advance in a predetermined area of the ROM that is included in the memory 120B. Further, this program is executed by the CPU 120A when the number of images data is received from the console 42.

In step S50 of FIG. 9, the CPU 120A controls the locking mechanisms 124 such that all of the power source devices 96 installed in the opening 40E are fixed (locked). Due to this processing, all of the power source devices 96 that are installed in the charging device 40 cannot be removed from the charging device 40.

In next step S52, the CPU 120A accesses, via the access sections 128, the memories 96B provided at all of the power source devices 96 installed in the opening 40E, and reads-out the respective number of times of low-speed charging, number of times of usual charging, and number of times of rapid charging that are stored in the memories 96B of the respective power source devices 96.

In next step S54, for example, the CPU 120A detects, via the charging sections 126, the output voltages and output currents of all of the power source devices 96 installed in the opening 40E. Due thereto, the CPU 120A detects, via the charging sections 126, the charged amounts (the charged electric powers) of the respective power source devices 96.

In subsequent step S56, the CPU 120A carries out, in the same way as in above step S12 and on the number of times of low-speed charging, the number of times of usual charging and the number of times of rapid charging of the respective power source devices 96 that were read-out by the processing of step S52, predetermined weighted addition by using weighting coefficients that are set such that, the greater the charge voltage, the greater the weighting coefficient per power source device 96. The CPU 120A detects the extents of deterioration of the respective power source devices 96 by considering that, the greater the value obtained by the results of addition, the more that power source device 96 has deteriorated.

In next step S58, the CPU 120A judges whether or not, among the charged electric powers of the respective power source devices 96 detected by the processing of above step S54, there is an electric power that is not less than the electric power sufficient to capture the planned number of images. If the judgment is affirmative, the routine moves on to step S64, whereas if the judgment is negative, the routine proceeds to step S60.

In step S60, the CPU 120A selects, as the power source device 96 to be installed in the electronic cassette 32, the power source device 96 whose charged electric power amount is greatest and that is closest to the electric power sufficient to capture the planned number of images. Note that, if there exist plural power source devices 96 that are closest to the electric power sufficient to capture the planned number of images, the CPU 120A may randomly select the power source device 96 to be installed in the electronic cassette 32 from among these plural power source devices 96, or may select the power source device 96 having the higher extent of deterioration.

In next step S62, the CPU 120A effects control, via the charging device I/F section 119, such that only the display portion 122A, that corresponds to the power source device 96 selected by the processing of above step S60, is set in a predetermined light-emitting state (a flashing state in the present exemplary embodiment) that indicates that the charged electric power does not meet the electric power sufficient to capture the planned number of images, but that that power source device 96 is the power source device 96 to be installed.

On the other hand, in step S64, the CPU 120A selects, as the power source device 96 to be installed in the electronic cassette 32, the power source device 96 whose extent of deterioration detected by the processing of above step S56 is highest among those power source devices whose charged electric power is not less than the electric power sufficient to capture the planned number of images. Note that if there exist plural power source devices 96 whose charged electric power is not less than the electric power sufficient to capture the planned number of images and whose extent of deterioration is the highest, the CPU 120A may randomly select the power source device 96 to be installed in the electronic cassette 32 from among these plural power source devices 96, or may select the power source device 96 whose charged electric power is greater.

In subsequent step S70, the CPU 120A controls, via the charging device I/F section 119, only the display portion 122A corresponding to the power source device 96 selected by the processing of above step S64. The CPU 120A controls this display portion 122A such that it is set in a predetermined light-emitting state (a constantly lit state in the present exemplary embodiment) that indicates that the charged electric power is not less than the electric power sufficient to capture the planned number of images, and that that power source device 96 is the power source device 96 to be installed.

In next step S72, the CPU 120A controls the locking mechanism 124 such that the locked state of the locking mechanism 124, that corresponds to the power source device 96 that was selected by the processing of above step S60 or above step S64, is released. Thereafter, the present program for indication of the power source device to be installed ends.

The person carrying out the imaging removes, from the charging device 40, the power source device 96 at which the light-emitting state of the display portion 122A is in the flashing state or the continually-lit state, and inserts the removed power source device 96 into the opening 32A of the electronic cassette 32. At this time, if the electric power charged at the power source device 96 does not meet the electric power sufficient to capture the planned number of images, the light-emitting state of the display portion 122A is made to be the flashing state. Due thereto, the person carrying out the imaging can know that the electric power charged at the power source device 96 that was removed does not meet the electric power sufficient to capture the planned number of images.

When the power source device 96 is inserted in the opening 32A, the plunger of the fixing member 32C projects-out, and the power source device 96 is fixed. Due thereto, electric power is supplied from the power source device 96 to the electronic cassette 32, and the capturing of radiation images becomes possible.

The person carrying out the imaging operation carries out preparations for imaging on the basis of the contents of the imaging order data displayed on the display 100, and carries out, with respect to the operation panel 102 of the console 42 and in accordance with the region to be imaged of the patient and the imaging conditions, exposure condition designating operation that designates the tube voltage, the tube current and the irradiation time period at the time of irradiating the radiation X.

When the exposure condition designating operation has been carried out with respect to the operation panel 102, the console 42 transmits the designated exposure conditions to the radiation generating device 34 and the electronic cassette 32. Due thereto, the radiation source controlling section 134 carries out exposure preparations at the received exposure conditions.

When the imaging preparations of the radiation generating device 34 are completed, the person carrying out the imaging carries out imaging instructing operation that instructs image capturing, with respect to the operation panel 102 of the console 42. When the imaging instructing operation is carried out with respect to the operation panel 102, the console 42 transmits instruction data that instructs the start of exposure to the radiation generating device 34 and the electronic cassette 32. Due thereto, the radiation source 130 generates and emits radiation at the tube voltage and the tube current and for the irradiation time period that correspond to the exposure conditions received from the console 42.

The radiation X irradiated from the radiation source 130 passes through the subject, and thereafter, reaches the electronic cassette 32. Due thereto, charges are accumulated in the storage capacitors 68 of the respective pixel portions 74 of the radiation detector 60 incorporated in the electronic cassette 32.

After the irradiation time period, that was designated by the exposure conditions, elapses from the receipt of the instruction data that instructs the start of exposure, the cassette control section 92 of the electronic cassette 32 controls the gate line driver 80 such that on signals are outputted from the gate line driver 80 to the respective gate lines 76 in order and line-by-line, and the respective TFTs 70 that are connected to the respective gate lines 76 are turned on in order and line-by-line.

When the respective TFTs 70 that are connected to the respective gate lines 76 are turned on in order and line-by-line, the radiation detector 60 causes the charges that are accumulated in the respective storage capacitors 68 to flow-out in order and line-by-line to the respective data lines 78 as electric signals. The electric signals, that have flowed-out to the respective data lines 78, are converted into digital image data at the signal processing section 82, and are stored in the image memory 90.

After imaging is finished, the cassette control section 92 transmits the image data, that is stored in the image memory 90, to the console 42 by wireless communication.

The console 42 carries out various types of image corrections, such as shading correction and the like, on the received image data, and stores the image data after correction in the HDD 110. The image data stored in the HDD 110 is displayed on the display 100 for confirming of the captured radiation image and the like, and is transferred via an unillustrated network to a server computer that structures the RIS (Radiology Information System) and is stored in a database as well. Due thereto, a doctor can carry out interpretation of the captured radiation image, diagnosis, and the like.

When the imaging is finished, due to the plunger of the fixing member 32C being pulled-in, a portion of the power source device 96 projects-out from the electronic cassette 32. The power source device 96 is removed from the electronic cassette 32, and is installed in the opening 40E of the charging device 40 and charged. The power source device 96 can thereby be reused.

In this way, by selecting the power source device 96 that is to be installed in the electronic cassette 32 as in the present exemplary embodiment, the fewer the planned number of images to be captured, the higher the frequency of selection of the power source device 96, that has a high extent of deterioration, becomes.

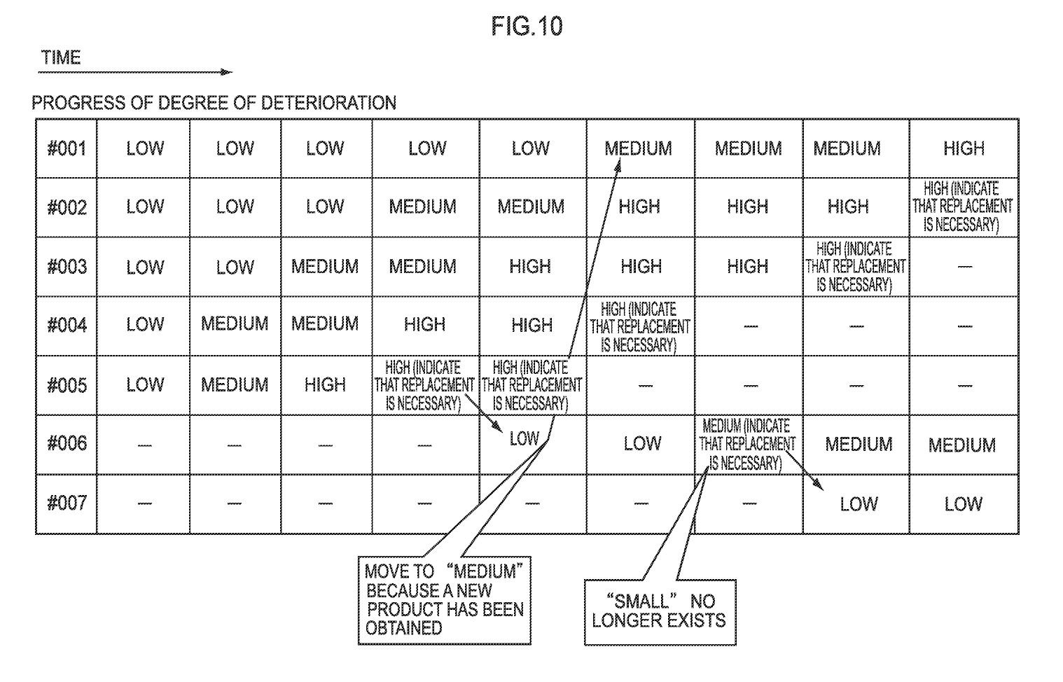

Changes in the extents of deterioration (low, medium, high) of the seven power source devices 96 (#001 through #007) are shown in FIG. 10.

The charged amount of the power source device 96, whose extent of deterioration is high, is small, and the number of radiation images that can be captured thereby is few. By using such a power source device 96 when the planned number of images to be captured is small, the power source device 96 can be utilized effectively.

On the other hand, the charged amount of the power source device 96, whose extent of deterioration is low, is large, and the number of radiation images that can be captured thereby is many. Therefore, by using such a power source device 96 when the planned number of images to be captured is large, image capturing can be carried out stably. Further, if the power source device 96 whose extent of deterioration is low is used in the capturing of a small planned number of images to be captured, the number of times that the power source device 96 is charged increases, and the power source device 96 deteriorates. Therefore, by making small the frequency of usage of this power source device in the capturing of a small planned number of images to be captured, the deterioration thereof can be suppressed.

### Second Exemplary Embodiment

A second exemplary embodiment of the present invention will be described next.

The structure of the radiology information system 10 relating to the second exemplary embodiment, and the structure of the electronic cassette 32, are the same as those of the above-described first exemplary embodiment (see FIG. 1 through FIG. 6). Accordingly, description thereof will be omitted here.

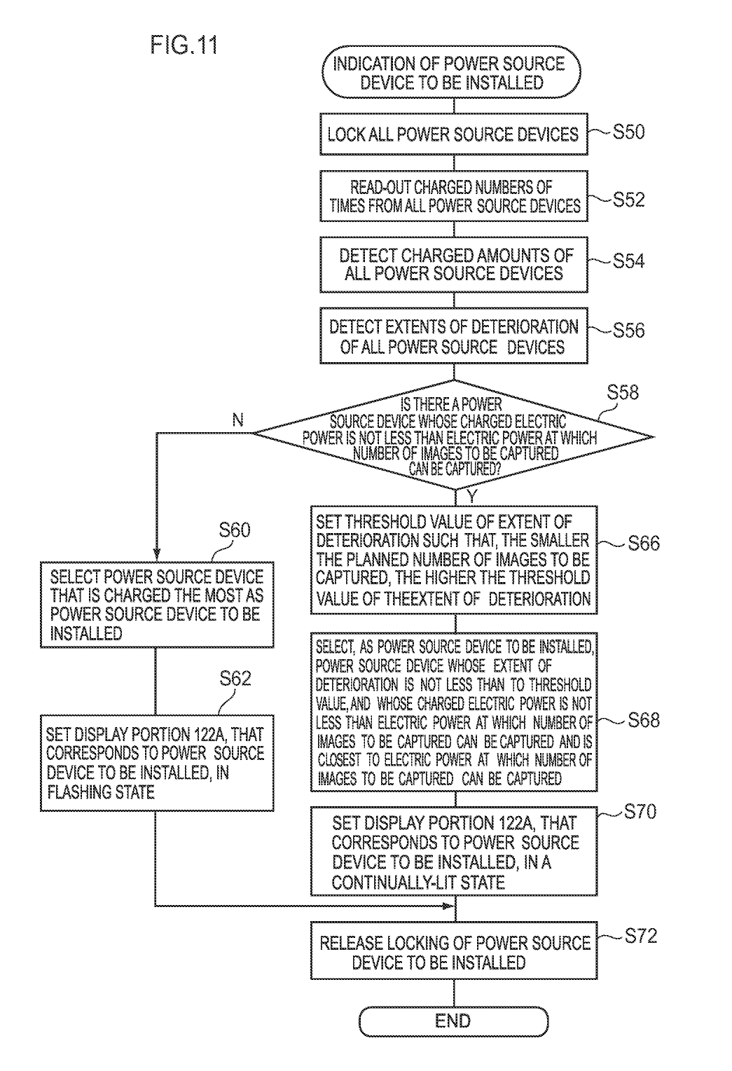

A flowchart showing the flow of processing of a program for indication of the power source device to be installed relating to the second exemplary embodiment is shown in FIG. 11. Note that portions that are the same as those of the above first exemplary embodiment (FIG. 9) are denoted by the same reference numerals, and description thereof is omitted.

In step S66, the CPU 120A sets the threshold value of the extent of deterioration such that, the fewer the planned number of images to be captured, the higher the threshold value of the extent of deterioration.

Due thereto, if the planned number of images to be captured is great, the threshold value of the extent of deterioration is low. If the planned number of images to be captured is small, the threshold value of the extent of deterioration is high.

In subsequent step S68, the CPU 120A selects, as the power source device 96 to be installed in the electronic cassette 32, the power source device 96 whose extent of deterioration detected by the processing of above step S56 is not less than the threshold value, and whose charged electric power is not less than the electric power sufficient to capture the planned number of images, and that is closest to the electric power sufficient to capture the planned number of images.

By selecting the power source device 96 that is to be installed in the electronic cassette 32 as in the present exemplary embodiment, the lower the planned number of images to be captured, the higher the threshold value of the extent of deterioration. Therefore, the frequency of usage of the power source device 96, whose extent of deterioration is high, becomes high.

Due thereto, a situation arising in which radiation images can no longer be captured due to deterioration of the power source device 96 can be suppressed, while the plural power source devices 96 are utilized effectively.

Note that, in the above-described first exemplary embodiment, the power source device 96, whose extent of deterioration is the highest among those power source devices whose charged electric power is not less than the electric power sufficient to capture the planned number of images, is selected as the power source device 96 to be installed in the electronic cassette 32. In the second exemplary embodiment, the threshold value of the extent of deterioration is set such that, the smaller the planned number of images to be captured, the higher the threshold value, and the power source device 96, whose extent of deterioration is not less than the threshold value and whose charged electric power is not less than the electric power sufficient to capture the planned number of images and that is closest to the electric power sufficient to capture the planned number of images, is selected as the power source device 96 to be installed in the electronic cassette 32. However, the present invention is not limited to the same, and the power source device 96 to be installed in the electronic cassette 32 may be selected in any way, provided that, the smaller the planned number of images to be captured, the higher the frequency of selection of the power source device 96, whose extent of deterioration is high, becomes. For example, the plural power source devices 96 may be divided, in accordance with the detected extents of deterioration thereof, into deterioration levels of predetermined, plural stages, and the power source device 96 to be installed in the electronic cassette 32 may be selected from among the power source devices 96 such that, the smaller the planned number of images to be captured, the higher the deterioration level of the power source device 96 that is selected. In this case, the power source device 96, whose charged electric power is closest to the electric power sufficient to capture the planned number of images, may be made to be the power source device 96 to be installed in the electronic cassette 32. Or, the power source device 96, that is charged the most, may be made to be the power source device 96 to be installed in the electronic cassette 32. This dividing into levels can be carried out by setting plural threshold values in accordance with deterioration levels of plural stages, and comparing the extents of deterioration of the power source devices 96 and the respective threshold values. Because the battery 96A utilizes chemical changes, there are cases in which the speed of progression of the deterioration changes due to the usage environment and usage frequency within a hospital, the maintained state, and the method of usage (cases in which few batteries are used and cases in which many batteries are used). Therefore, an operation panel or the like may be provided at the power source device 96, and the respective threshold values of the deterioration levels and/or a threshold value of the replacement level may be set from this operation panel, or may be set from the operation panel 102 of the console 42. Further, the respective threshold values of the deterioration levels and/or the threshold value of the replacement level may be changed automatically by the CPU 120A of the charging device control section 120 or the CPU 104 of the console 42 in accordance with the usage environment and usage frequency and the like within a hospital, the maintained state, and the method of usage. Moreover, the respective threshold values of the deterioration levels and/or the threshold value of the replacement level may be changed automatically by the CPU 120A of the charging device control section 120 or the CPU 104 of the console 42 in accordance with the number or the proportion of the power source devices 96 at each of the deterioration levels. For example, if the number of power source devices 96 having the highest deterioration level (high level in the present exemplary embodiment) is not less than a predetermined proportion (e.g., 40%), replacement of the power source devices 96 can be accelerated by lowering the threshold value of the replacement level.

The above exemplary embodiments describe cases in which the extent of deterioration is detected from the number of times of charging, but the present invention is not limited to the same. For example, the speed of deterioration becomes more rapid when the temperature at which the battery 96A is used exceeds a predetermined appropriate range, or when excessive discharging of the battery 96A is carried out. Accordingly, the extent of deterioration may be detected as follows: the temperatures at the time of charging and at the time of discharging may be monitored. An exceeding number of times or time periods when the temperature exceeds the predetermined appropriate range, and/or a discharged number of times when discharging is carried out excessively, may be stored in the memory 96B. The exceeding number of times and/or the discharged number of times may be further weighted and added so as to detect the extent of deterioration.

Further, there are cases in which the electrical characteristics change in accordance with the deterioration. For example, the more a lithium ion battery deteriorates, the more the impedance increases. Therefore, the extent of deterioration of a battery may be detected by detecting changes in the electrical characteristics of the battery 96A. In this case, a detecting section, that detects changes in the electrical characteristics, corresponds to the detecting unit of the present invention.

Further, the above respective exemplary embodiments describe cases of executing the charging control processing program and the program for indication of the power source device to be installed at the CPU 120A of the charging device control section 120 of the charging device 40. However, the present invention is not limited to the same. For example, the CPU 104 of the console 42 may, via the charging device I/F 119, control the display sections 122, the locking mechanisms 124, the charging sections 126 and the access sections 128 of the charging device 40, and the charging control processing program and the program for indication of the power source device to be installed may be executed at the CPU 104 of the console 42. In this case, the CPU 104 of the console 42 corresponds to the selecting unit of the present invention. Further, if weighted addition of the charged number of times, or the exceeding number of times, the discharged number of times is executed at the CPU 104 of the console 42, the CPU 104 of the console 42 corresponds to the detecting unit of the present invention.

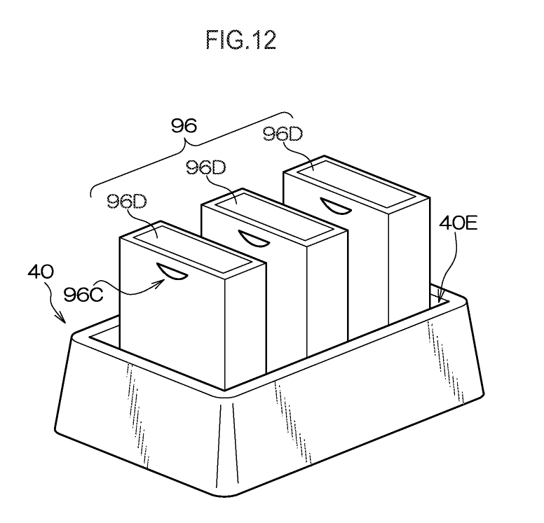

In the above respective exemplary embodiments, the display portions 122 are provided at the charging device 40 so as to indicate whether or not the power source devices 96 can be used and whether or not replacement is necessary. However, the present invention is not limited to the same. For example, display portions that can display images or characters may be provided at the charging device 40. Further, as shown in FIG. 12, display portions 96D may be provided at the top surfaces of the power source devices 96, and display may be carried out at the display portions 96D. A liquid crystal display, an organic EL display, a plasma display, electronic paper, or the like can be used as the display portion 96D. Moreover, warning messages and images may be displayed on the display 100 of the console 42. In addition, whether or not a power source device can be used and whether or not a power source device must be replaced can be indicated by sound or the like. If warning messages or images are displayed on the display 100 of the console 42, the display 100 corresponds to the indicating unit of the present invention.

The above exemplary embodiments describe cases in which the charged numbers of times are stored in the memories 96B of the power source devices 96 respectively, but the present invention is not limited to the same. For example, identification data, such as an ID code or the like that identifies the power source device 96, may be stored in the memories 96B of the power source devices 96, and data that correlates the deterioration, such as the charged number of times or the like, with the corresponding identification data may be stored in the storage 120C of the power source device 96 or in the HDD 110 of the console 42.

The respective exemplary embodiments describe cases that indicate that it is necessary to replace the power source device 96 whose extent of deterioration is greater than or equal to a replacement level. However, the present invention is not limited to the same. For example, if the proportion occupied by the power source devices 96 whose extents of deterioration are low level, with respect to all of the power source devices, is less than or equal to a predetermined proportion (e.g., 40%), it may be indicated that it is necessary to replace the power source device 96 having the highest extent of deterioration.

Further, the above exemplary embodiments describe cases in which number of images data, that expresses the planned number of images to be captured, is inputted from the console 42 to the charging device 40, but the present invention is not limited to the same. For example, an operation panel that accepts the planned number of images to be captured may be provided at the charging device 40, and the planned number of images to be captured may be acquired from this operation panel. Further, when the CPU 104 of the console 42 controls, via the charging device I/F 119, the display portions 122, the locking mechanisms 124, the charging sections 126 and the access sections 128 of the charging device 40, the planned number of images to be captured may be acquired at the operation panel 102.

Moreover, the structure of the RIS 10 (see FIG. 1), the structure of the radiation imaging room 44 (see FIG. 2), the structure of the electronic cassette 32 (see FIG. 3 and FIG. 5), the structure of the charging device 40 (see FIG. 4), and the structure of the imaging system 18 (see FIG. 6) that are described in the above exemplary embodiment are examples. Unnecessary portions may be eliminated therefrom, new portions may be added thereto, or the states of connection may be changed, within a scope that does not deviate from the gist of the present invention.

Further, the structure of the imaging order data (see FIG. 8) explained in the above exemplary embodiment is an example, and unnecessary data may be eliminated therefrom, new data may be added thereto, or the data may be changed, within a scope that does not deviate from the gist of the present invention.

The flow of the processing of the charging control processing program and the program for indication of the power source device to be installed that were explained in the above exemplary embodiments (see FIG. 7, FIG. 11, FIG. 12) also are examples, and unnecessary steps may be eliminated therefrom, new steps may be added thereto, or order of the processing may be rearranged, within a scope that does not deviate from the gist of the present invention.

In accordance with the aspect of the present invention, the plural secondary batteries, that can be installed in and removed from the portable radiation imaging device, are charged by the charging unit. The extent of deterioration of each of the plural secondary batteries is detected by the detecting unit.

Further, in accordance with the aspect of the present invention, the secondary battery to be installed in the portable radiation imaging device is selected by the selecting unit such that, the smaller a planned number of images to be captured by the portable radiation imaging device, the higher the frequency of selection of a secondary battery, that has a high extent of deterioration, becomes. The secondary battery that is selected is indicated by the indicating unit.

In this way, in accordance with the aspect of the present invention, the plural secondary batteries are charged, and the respective extents of deterioration of the plural secondary batteries are detected. The secondary battery that is to be installed in the portable radiation imaging device is selected such that, the smaller the planned number of images to be captured, the higher the frequency of selection of a secondary battery, whose extent of deterioration is high, becomes. Because the selected secondary battery is indicated, the indicated secondary battery is installed in the portable radiation imaging device, and capturing of radiation images is carried out. Due thereto, a situation, in which radiation images can no longer be captured due to deterioration of the secondary battery, arising can be suppressed, while the plural secondary batteries are utilized effectively.

Note that the charging device of the aspect of the present invention may further have one of an inputting unit at which at least number of images data, that expresses the planned number of images to be captured, is inputted, and an acquiring unit that acquires the number of images data.

Further, in accordance with the aspect of the present invention, the selecting unit may select, as the secondary battery to be installed in the portable radiation imaging device, a secondary battery whose extent of deterioration is highest among those second batteries whose electric power is not less than an electric power sufficient to capture the planned number of images.

Moreover, in accordance with the aspect of the present invention, the selecting unit may set a threshold value of an extent of deterioration such that, the smaller the planned number of images to be captured, the higher the threshold value of the extent of deterioration, and the selecting unit may select, as the secondary battery to be installed in the portable radiation imaging device, a secondary battery whose extent of deterioration is not less than the threshold value, and whose electric power is not less than an electric power sufficient to capture the planned number of images and is closest to the electric power sufficient to capture the planned number of images.

Further, in accordance with the aspect of the present invention, the selecting unit may divide the plural secondary batteries into deterioration levels of predetermined plural stages in accordance with the extent of deterioration, and the selecting unit may select the secondary battery to be installed in the portable radiation imaging device from among secondary batteries such that, the smaller the planned number of images to be captured, for which image capturing is to be carried out by the portable radiation imaging device, the higher the deterioration level of the secondary battery that is selected.

In accordance with this aspect, the selecting unit may select, as the secondary battery to be installed in the portable radiation imaging device, a secondary battery whose electric power is closest to an electric power sufficient to capture the planned number of images, or a secondary battery that is most charged.

In accordance with the aspect of the present invention, the selecting unit may carry out division into the deterioration levels of the predetermined plural stages by comparing the extent of deterioration with plural threshold values that are determined in advance in accordance with the deterioration levels of the predetermined plural stages.

The charging device of the aspect of the present invention may further have a setting unit that sets the plural threshold values.

Further, in accordance with the aspect of the present invention, when there does not exist a secondary battery whose electric power is not less than the electric power sufficient to capture the planned number of images, the selecting unit may select, as the secondary battery to be installed in the portable radiation imaging device, a secondary battery that is closest to the electric power sufficient to capture the planned number of images.

Moreover, in accordance with the aspect of the present invention, the planned number of images to be captured may be a total of a number of images to be captured for which imaging is requested in one imaging order, or of a number of images for which imaging is requested in plural imaging orders for which imaging is to be carried out in a state in which the secondary battery is installed one time in the portable radiation imaging device.

In accordance with the aspect of the present invention, the charging unit may be structured so as to carry out high-speed charging by making electric power, that is supplied in charging of the secondary battery, be large, and may carry out high-speed charging with respect to a secondary battery whose extent of deterioration is greater than or equal to a predetermined extent of deterioration.

According to an aspect of the present invention, while plural secondary batteries are utilized effectively, it is possible to suppress a situation arising in which radiation images can no longer be captured due to deterioration of a secondary battery.

In accordance with the aspects of the present invention, a situation, in which radiation images can no longer be captured due to deterioration of the secondary battery, arising can be suppressed, while the plural secondary batteries are utilized effectively.

What is claimed is:

1. A charging device comprising:
a charging unit that charges a plurality of secondary batteries that supply electric power to a portable radiation imaging device, each of the plurality of secondary batteries being able to be installed in or removed from the portable radiation imaging device;
a detecting unit that detects an extent of deterioration of each of the plurality of secondary batteries;
a selecting unit that selects a secondary battery to be installed in the portable radiation imaging device such that, the smaller a planned number of images to be captured by the portable radiation imaging device, the higher the frequency of selection of a secondary battery, whose extent of deterioration is high, becomes; and
an indicating unit that indicates the secondary battery selected by the selecting unit.

2. The charging device of claim 1, further comprising one of an inputting unit at which at least number of images data, that expresses the planned number of images to be captured, is inputted, and an acquiring unit that acquires the number of images data.

3. The charging device of claim 1, wherein the selecting unit selects a secondary battery whose extent of deterioration is highest among those secondary batteries each having the electric power is not less than an electric power sufficient to capture the planned number of images.

4. The charging device of claim 1, wherein the selecting unit sets a threshold value of an extent of deterioration such that, the smaller the planned number of images to be captured, the higher the threshold value of the extent of deterioration, and the selecting unit selects a secondary battery whose extent of deterioration is not less than the threshold value, and whose electric power is not less than an electric power sufficient to capture the planned number of images and is closest to the electric power sufficient to capture the planned number of images.

5. The charging device of claim 1, wherein the selecting unit divides the plurality of secondary batteries into deterioration levels of a predetermined plurality of stages in accordance with the extent of deterioration, and the selecting unit selects the secondary battery such that, the smaller the planned number of images to be captured, the higher the deterioration level of the secondary battery that is selected.

6. The charging device of claim 5, wherein the selecting unit selects a secondary battery whose electric power charged by the charging unit is closest to an electric power sufficient to capture the planned number of images, or a secondary battery that is most charged.

7. The charging device of claim 5, wherein the selecting unit carries out division into the deterioration levels of the predetermined plurality of stages by comparing the extent of deterioration with a plurality of threshold values that are determined in advance in accordance with the deterioration levels of the predetermined plurality of stages.

8. The charging device of claim 7, further comprising a setting unit that sets the plurality of threshold values.

9. The charging device of claim 3, wherein, when there does not exist a secondary battery whose electric power charged by the charging unit is not less than the electric power sufficient to capture the planned number of images, the selecting unit selects, as the secondary battery to be installed in the portable radiation imaging device, a secondary battery that is closest to the electric power sufficient to capture the planned number of images.

10. The charging device of claim 1, wherein the planned number of images to be captured is a total of a number of images to be captured for which imaging is requested in one imaging order, or of a number of images for which imaging is requested in a plurality of imaging orders for which imaging is to be carried out in a state in which the secondary battery is installed one time in the portable radiation imaging device.

11. The charging device of claim 1, wherein the charging unit carries out high-speed charging by increasing the electric power, that is supplied in charging of the secondary battery, and carries out high-speed charging with respect to a secondary battery whose extent of deterioration is not less than a predetermined extent of deterioration.

12. A charging system comprising:
a charging device that charges a plurality of secondary batteries that supply electric power to a portable radiation imaging device, each of the second batteries being able to be installed in or removed from the portable radiation imaging device;
a detecting unit that detects an extent of deterioration of each of the plurality of secondary batteries;
a selecting unit that selects a secondary battery to be installed in the portable radiation imaging device such that, the smaller a planned number of images to be captured by the portable radiation imaging device, the higher the frequency of selection of a secondary battery, whose extent of deterioration is high, becomes; and
an indicating unit that indicates the secondary battery selected by the selecting unit.

13. A method of selecting a secondary battery in a charging device that charges a plurality of secondary batteries that supply electric power to a portable radiation imaging device, each of the second batteries being able to be installed in or removed from the portable radiation imaging device, the method comprising:
detecting an extent of deterioration of each of the plurality of secondary batteries;
selecting a secondary battery to be installed in the portable radiation imaging device such that, the smaller a planned number of images to be captured by the portable radiation imaging device, the higher the frequency of selection of a secondary battery, whose extent of deterioration is high, becomes; and
indicating the secondary battery that was selected.

14. The method of claim 13, wherein selecting a secondary battery includes selecting a secondary battery whose extent of deterioration is highest among those second batteries whose electric power is not less than an electric power sufficient to capture the planned number of images.

15. The method of claim 13, wherein selecting a secondary battery includes setting a threshold value of an extent of deterioration such that, the smaller the planned number of images to be captured, the higher the threshold value of the extent of deterioration, and includes selecting a secondary battery whose extent of deterioration is not less than the threshold value, and whose electric power is not less than an electric power sufficient to capture the planned number of images and is closest to the electric power sufficient to capture the planned number of images.

16. The method of claim 13, wherein selecting a secondary battery includes dividing the plurality of secondary batteries into deterioration levels of a predetermined plurality of stages in accordance with the extent of deterioration, and includes selecting a secondary battery such that, the smaller the planned number of images to be captured by the portable radiation imaging device, the higher the deterioration level of the secondary battery that is selected.

17. The charging device of claim 8, wherein the setting unit lowers the plurality of threshold values when a number of secondary batteries of a highest deterioration level is not less than a predetermined proportion.
